(19) United States
(12) Patent Application Publication
(10) Pub. No.: US 2019/0388739 A1
(43) Pub. Date: Dec. 26, 2019

(54) METHOD OF MANUFACTURING ROPE TO MOLDED PART

(71) Applicant: The Step 2 Company, LLC, Streetsboro, OH (US)

(72) Inventor: Patrick Ritossa, Chesterland, OH (US)

(73) Assignee: The Step 2 Company, LLC, Streetsboro, OH (US)

(21) Appl. No.: 16/448,347

(22) Filed: Jun. 21, 2019

Related U.S. Application Data
(60) Provisional application No. 62/688,907, filed on Jun. 22, 2018.

(51) Int. Cl. A63B 45/00; A63B 43/00; B29C 41/04; B29C 41/20

(52) U.S. Cl. CPC A63B 45/00; A63B 43/007; B29L 2031/529; B29C 41/20; B29C 41/04

(57) ABSTRACT

Provided is a manufacturing method for inserting an attachment device into a rotationally-molded product. An attachment device is provided having a first point, a second point having a cross-sectional area larger than the first point, and a flange including a back surface and a neck having a cross-sectional area smaller than the second point and the back surface. An end of a rope element is affixed to the attachment device. A ball-like element is molded. The attachment device is inserted into an opening in the ball-like element while the ball-like element is between 150 degrees Fahrenheit to 300 degrees Fahrenheit.

### I. BACKGROUND

### A. Technical Field

This invention pertains to an article and method for manufacturing the article. The article is a toy, such as might be used with a child or perhaps with a pet. The toy essentially comprises a ball-like element to which a rope-like element is attached.

### B. Description of Related Art

It is known to provide toys to children and to pets for their enjoyment. It is also known that many of these toys involve a ball which can be thrown or otherwise gripped and enjoyed by the child or the pet. It is also known that pets, in particular, enjoy pulling on a rope and will often play “tug of war” with a human. While there are a variety of balls, and a variety of toys for pets, there remained a need for a ball-like toy with a rope, or other rope-like implement attached firmly, or even permanently, thereto.

### II. SUMMARY

Provided in this disclosure is an article and method of manufacture which features a ball-like element, a rope-like element, an attachment device and a distal end of the rope to which other elements may be attached, or which may be gripped by the human user.

Therefore, an article is provided which provides utility to humans, children, and to pets for throwing and for the purposes of playing tug of war games.

According to one aspect of the invention, the ball-like element is sized to fit neatly into the hand of a child, or the mouth of a pet, such as a dog.

According to another aspect of the invention, the attachment device is attached to a first end of the rope and the attachment device is mounted, essentially permanently, into the interior of the ball-like element.

According to another aspect of the invention, an innovative manufacturing method for the article is disclosed.

Other benefits and advantages of this invention will become apparent to those skilled in the art to which it pertains upon reading and understanding of the following detailed specification.

### III. BRIEF DESCRIPTION OF THE DRAWINGS

The disclosed article and manufacturing method for making the same, and corresponding methods and systems may take physical form in certain parts and arrangement of parts, embodiments of which will be described in detail in this specification and illustrated in the accompanying drawings which form a part hereof and wherein:

FIG. 1 is a front view of the article;

FIG. 2 is a front view of the article showing the rope element separate from the ball element;

FIG. 3 is an alternate embodiment of the article, where the distal end of the rope is a knotted rope with a frayed end;

FIG. 4 is a close-up view of the rope element as shown in FIG. 3;

FIG. 5A is an exploded view of one embodiment of the rope element;

FIG. 5B is a schematic view of one embodiment of the rope element shown inserted into the ball element;

FIG. 6 is a representation of different sizes of one embodiment of the invention;

FIG. 7 shows various types of ball elements that might be included with the invention;

FIG. 8 is a representation of one preferred embodiment of the invention showing a ball-like element molded to resemble a soccer ball and a rope-like element using a nylon rope, knotted end, and knotted rope with a frayed end; and

FIG. 9 shows the ball-like element in a mold.

### IV. DETAILED DESCRIPTION

Referring now to the drawings wherein the showings are for purposes of illustrating embodiments of the article only and not for purposes of limiting the same, and wherein like reference numerals are understood to refer to like components.

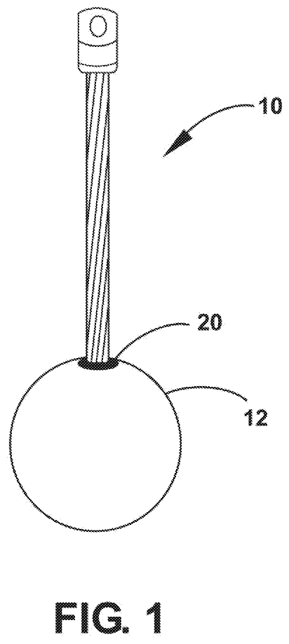

With reference to FIG. 1, the article 10 is shown, where the article includes a ball-like element 12 which hereinafter will be referred to as the “ball” although other versions of the ball-like element 12 are within the scope of the invention that are not necessarily balls. For example, the ball-like element 12 could involve cubicle forms, or various polygonal forms other than spherical. However, for ease of reference, the ball-like element 12 shall hereinafter be referred to as a “ball.” At one point on the exterior surface of the ball 12 an opening 20 is provided.

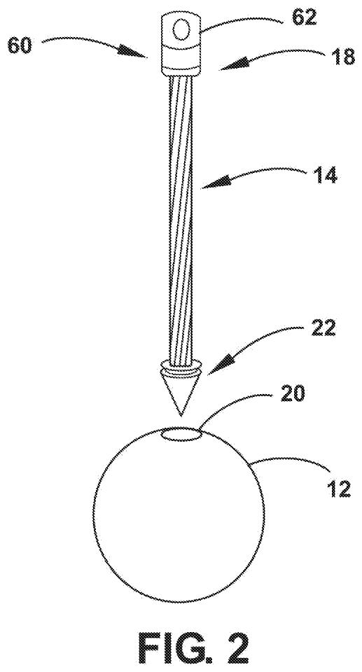

With reference to FIG. 2, a rope-like element 14 is shown. The rope-like element 14 has a first end 22 and a distal end 18. The “rope-like element” 14 preferably takes the form of a rope, but similar to the ball-like element, the rope-like element 14 can take various forms, some of which are not rope-like. For example, the rope-like element 14 can be rigid, and be more like a rod in such cases. However, for ease of illustration, the rope-like element 14 shall hereinafter be referred to as “rope.”

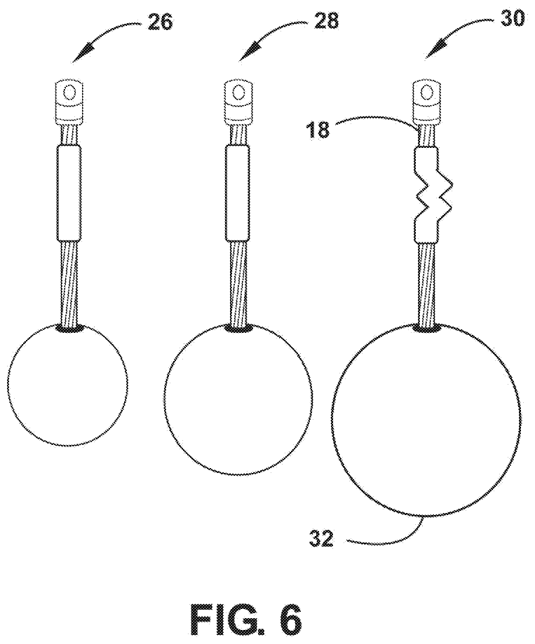

With reference to FIG. 6, the article 10 can be configured to have various sizes to fit the application. Generally, the different sizes will be chosen to fit the child, or the pet most likely to play with the device. Some preferred sizes include balls 12 with volumes of 11.7 cubic inches, 21.2 cubic inches or 38.3 cubic inches. In each case, the ball 12 has a preferred wall thickness of 0.2 inches.

With continuing reference to FIG. 6, in the “small” version of the article, the ball 12 has a volume of 11.7 cubic inches and the distance from the distal end 32 of the ball 12 to the distal end 18 of the rope 14 is 16 inches. In the “medium” version of the article, the ball 12 has a volume of 21.2 cubic inches and an overall length, from the distal end 32 of the ball 12 to the distal end 18 of the rope 14 of 18 inches. Finally, in the “large” version 30 of the article 10 the ball 12 has a volume of 38.3 cubic inches and an overall length from the distal end 32 of the ball 12 to the distal end 18 of the rope 14 of 20 inches. In each case, the wall thickness of the ball is 0.2 inches.

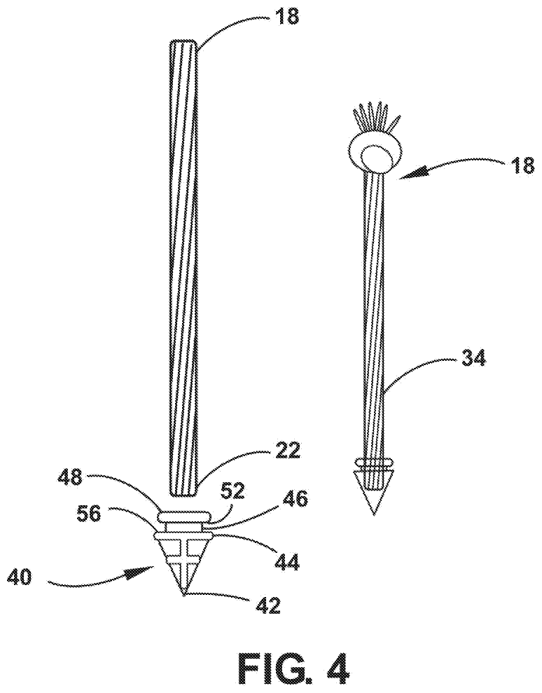

With reference to FIGS. 2, 4, 5A and 5B, the rope-like element 14 will be more fully described. With particular reference to FIG. 4, the rope-like element 14 includes a rope body 34 having a distal end 18 and a first end 22. The first end 22 of the rope-like element 14 is permanently affixed to an attachment device 40. The attachment device 40 may take a variety of forms, but in the preferred embodiment it has a first point 42 (also called a first end or first location) that is narrower and has less cross sectional area than a second point 44. The second point 44 is generally opposite to the first point 42 on the attachment device 40. A neck or third point 46 of the attachment device 40 has a tapered diameter that thus has a smaller cross-sectional area than that of the second point 44. In essence, the attachment device 40 has a shape similar to an arrowhead, where the first point 42 is a tip at the narrowest part of the arrowhead, having the smallest cross-sectional area. The arrowhead shape operates similarly to an arrowhead during manufacturing, as described in detail hereinbelow. The second point 44 is the widest part of the arrowhead, having the largest cross-sectional area, or at least larger than that of the first point 42. The third point 46 is shaped like the “tang” of an arrowhead, having a smaller cross-sectional area than the second point 44.

With specific reference to FIGS. 2 and 4, the attachment device 40 includes a back surface 48 formed as a flange, having a raised rim above the second point 44, with the neck or third point 46 is a portion with a tapered diameter, having a smaller width and cross sectional area than both the back surface 48 and the second point 44. The flange including the back surface 48 and the neck 46 is generally in contact with the second point 44. As is evident from FIG. 2, the attachment device 40 is preferably of a generally conical shape, having a portion from the first point 42 to the second point 44 in the tapered shape of a converging cone. The attachment device 40 is rotationally symmetrical about the central conical axis of the conical shape, where the cross sectional areas, perpendicular to the central conical axis, of the first point 42, second point 44, third point 46 and back surface 48, are generally circular.

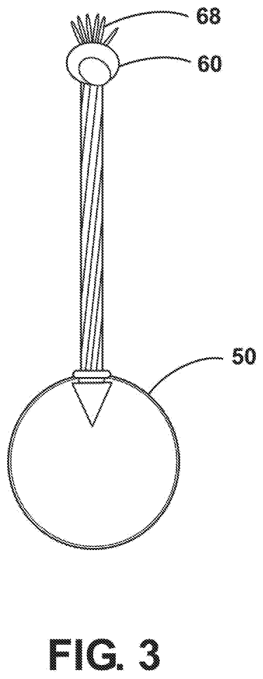

With continuing reference to FIG. 4, as well as to FIGS. 2, 3, 5A, and 5B, the attachment device 40 is permanently, or perhaps selectively, inserted into the ball-like element 12 through a press fit. The shape of the attachment device 40 provides that, when pressure is applied to the back surface 48 of the attachment device 40, the first point 42 penetrates the ball 12 at the opening 20, similar to the operation of an arrowhead in penetrating a target. Resistance increases as the attachment device 40 is pushed into the ball 12 at the opening 20. At some point, the wall 50 of the ball 12 slips past the second point 44 and affixes itself into the attachment device 40 at the neck of the third point 46. The edges of the opening 20 sit between the third point 46 and a flange surface 52 on an underside of the back surface 48 of the attachment device 48 and secure the attachment device 40 within the ball 12, as illustrated in FIG. 1 and in FIG. 3. The first flange surface 52 and the second flange surface 56 are juxtaposed on either side of the wall 50 of the ball 12.

The insertion of the attachment device 40 within the ball 12 is most easily accomplished soon after the ball 12 is molded. Therefore, while the ball 12 is still warm, and therefore more ductile and less rigid, the attachment device 40 is advantageously inserted, as shown in FIGS. 1, 2, 3, and 5B.

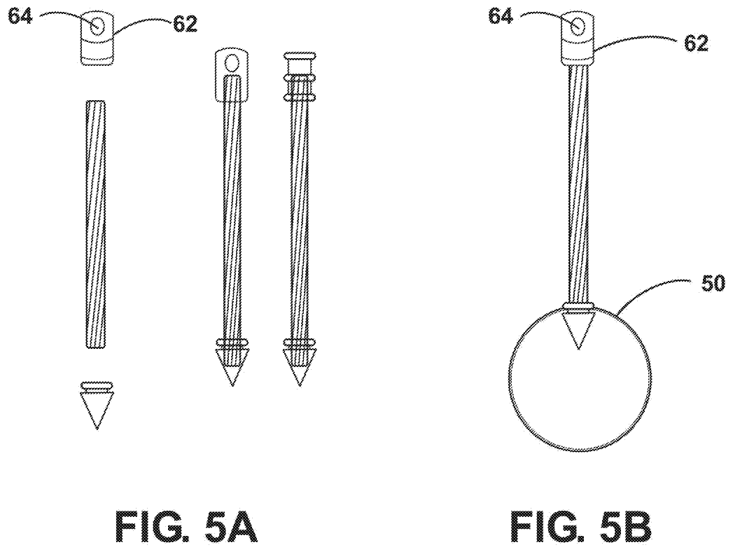

With reference to FIG. 5A, the end effect 60 can take different forms. One preferred form is of a handle 62. The handle includes a hole 64. With continuing reference to FIG. 5A, the preferred dimensions of the handle 62 shown, having a length of about 2 inches and a width about 1.5 inches. The handle 62, if molded, has a volume of 1.06 cubic inches.

With reference to FIGS. 3, 4, and 8, a second embodiment of the end effect 60 is a knotted rope with frayed ends. The knot 66 is clearly shown in FIG. 3 along with the frayed ends 68.

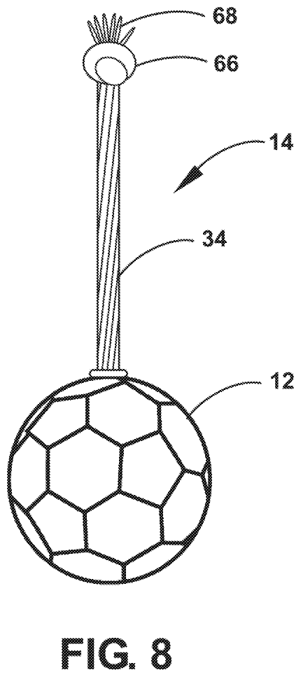

With reference to FIG. 8, a preferred ball-like element 12 is shown with the panels of a soccer ball molded therein. The rope-like element 14 along with the rope body 34, knot 66, and frayed ends 68 are shown.

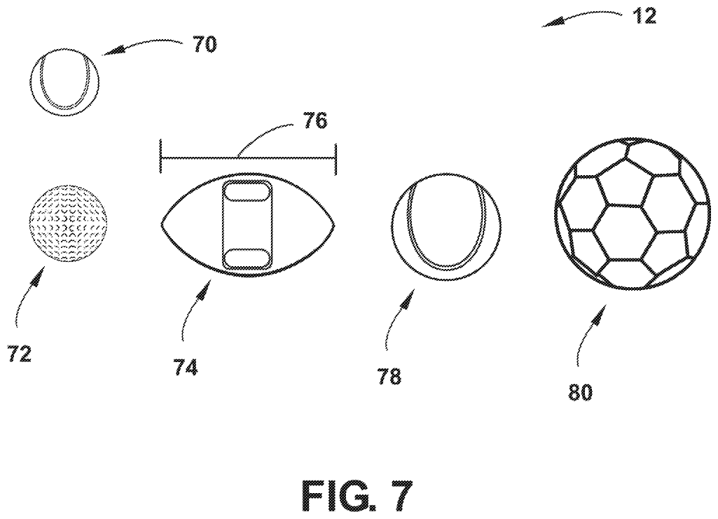

With reference to FIG. 7, a variety of ball-like elements 12 are shown. One preferred embodiment of the ball-like element 12 is shown as a tennis ball 70. In this embodiment, the surface area of the preferred ball is 67.7 square inches. With continuing reference to FIG. 7, a second preferred embodiment of the ball-like element 12 is molded as a golf ball 72. In this embodiment, the golf ball is about 4.5 inches in diameter and has a surface area of 67.4 square inches. With continuing reference to FIG. 7, another preferred shape of the ball-like element 12 is a football 74. The football 74 is 6 inches along its longest diameter 76 and has a surface area of 112.7 square inches. With continuing reference to FIG. 7, another preferred embodiment is a larger tennis ball 78 with a surface area of 120.4 square inches. Finally, with continuing reference to FIG. 7, another preferred embodiment of the ball-like element 12 is a soccer ball 80 which as a diameter of approximately 8 inches and a surface area of approximately 226.5 square inches. A similar pattern, and size, could be used for a volleyball or a basketball, and are contemplated within the scope of the invention.

The rope-like element 14 can be a rod which is semi-rigid or even rigid, can be made of any material chosen with sound engineering judgement. As described herein, a currently preferred rope-like element 14 is a nylon rope as shown in several of the figures, such as FIG. 8. One preferred end effector 60 is the handle 62 shown in FIGS. 5A and 5B, while another preferred end effector 60 is a knot 66 and frayed end 68 as shown in other figures, such as FIG. 8.

One element of the invention is the affixation or attachment of the rope-like element 14 to the ball-like element 12. In the preferred embodiment, a round opening 20 is formed into the ball 14 so as to better receive the attachment device 40. The attachment device does not have to take the shape shown in the figures but does have to have a surface, such as the aforementioned second point 44 which is of greater diameter and cross section than the first point 42 and the third point 46. In other words, the flange having flange surfaces 46, 52, 56 as shown in FIG. 4 and elsewhere is helpful to allow retention of the rope-like element 14 to the ball-like element 12.

One aspect of the invention is the manufacturing method. The ball-like element 12 is preferably made of plastic. One embodiment uses polyethylene resin. One resin is an experimental resin available from Dow Chemical Company and designated by XUS 58441.00 Polyolefin Plastomer. As mentioned previously, the preferred wall thickness is 0.2 inches. In the preferred manufacturing method, the ball-like element 12 is rotationally molded, although other manufacturing methods, such as transfer molding or injection molding can be advantageously used and are contemplated in the scope of this invention.

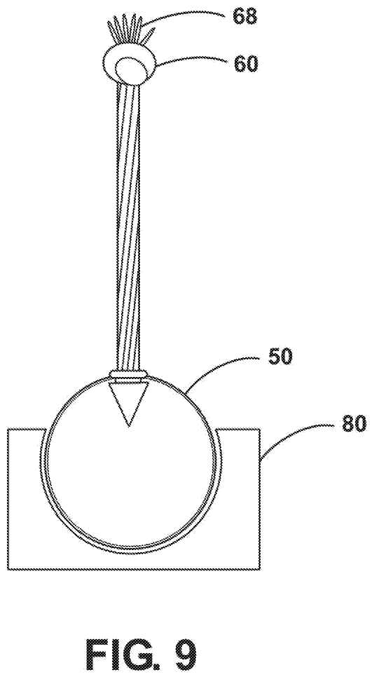

The inventor has learned that better results are obtained when the attachment device 40 is inserted into the ball-like element 12 when the ball-like element 12 is still warm from the molding process. The attachment device 40 may be inserted into the ball-like element 12 while the ball-like element 12 is still in the mold, as shown in FIG. 9, or just recently removed from the associated mold. When so warmed, the ball-like element 12 is more pliable and can more easily receive the attachment element 40. The flange surfaces 46, 52, 56 need to be resiliently deformable to receive the wall 50 of the ball-like element 12. Typically, in a rotational molding process, the ball-like element will exit the mold at about 225 degrees Fahrenheit, and this is a good temperature for the insertion of the attachment device 40. However, good results are attainable at lower temperatures and higher temperatures, depending on the durometer measurements of the resin and the behavior during the molding process. Temperature ranges of 150 degrees Fahrenheit to 300 degrees Fahrenheit are believed to be acceptable.

The innovative manufacturing method can be applied to other products other than those shown herein. Whenever an attachment device 40, or a similar configuration, needs to be fitted into a molded part, such as a rotationally molded part, this system will be an option.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed:

1. A manufacturing method, comprising:
providing an attachment device having a first point, a second point generally opposite to the first point on the attachment device, the second point having a cross-sectional area larger than the first point, and a flange including a back surface and a neck generally in contact with the second point, the neck having a cross-sectional area smaller than the second point and the back surface;
affixing an end of a rope-like element to the attachment device;
molding a ball-like element; and
inserting the attachment device into an opening in the ball-like element while the ball-like element is between 150 degrees Fahrenheit to 300 degrees Fahrenheit.

2. The manufacturing method of claim 1, wherein the attachment device is inserted into the ball-like element through a press fit.

3. The manufacturing method of claim 2, wherein the press fit comprises applying pressure to the back surface of the attachment device so that the first point penetrates the ball-like element at the opening.

4. The manufacturing method of claim 3, wherein the press fit further comprises applying pressure to the back surface of the attachment device so that a wall of the ball-like element slips past the second point and affixes itself into the attachment device at the neck so that edges of the opening in the ball-like element sit between the neck and a flange surface on an underside of the back surface of the attachment device.

5. The manufacturing method of claim 1, wherein the molding comprises molding with polyethylene resin.

6. The manufacturing method of claim 1, wherein the molding comprises rotational molding.

7. The manufacturing method of claim 1, wherein the inserting is performed while the ball-like element is still in the mold.

8. The manufacturing method of claim 1, wherein the inserting is performed just after the ball-like element has been removed from the mold.

9. The manufacturing method of claim 1, wherein the inserting is performed when the ball-like element exits the mold at about 225 degrees Fahrenheit.
